(19) United States
(12) Patent Application Publication
(10) Pub. No.: US 2002/0056166 A1
(43) Pub. Date: May 16, 2002

(54) Internal cylindrical surface cleaning apparatus

(76) Inventor: Gordon Clunie, Saskatoon (CA)

Correspondence Address: Welsh & Katz, Ltd., Daniel M. Gurfinkel, 22nd Floor, 120 South Riverside Plaza, Chicago, IL, 60606, US

(21) Appl. No.: 09/993,134

(22) Filed: Nov. 14, 2001

(30) Foreign Application Priority Data
Nov. 15, 2000 (CA) 2,325,974

(51) Int. Cl. B08B 9/027

(52) U.S. Cl. 15/104.095; 15/104.09; 15/104.13

(57) ABSTRACT

An apparatus for removing deposits from the internal surface of a substantially cylindrical tube comprises a cap adapted to cover a first end of the tube and defining a hole. A shaft is slidably and rotatably mounted in the hole and a plurality of cutters extend outward from an inside end of the shaft, spaced about the exterior of the shaft, each cutter movable from a retracted position outward from the shaft to an extended position. A bias force supplied by a pressurized fluid source acts on each cutter toward the extended position. A drive is operative to rotate the shaft as the shaft slides along the hole. A channel can be provided to supply pressurized fluid to an interior of a tube to blow debris out.

This invention is in the field cleaning and removing deposits and in particular cleaning and removing deposits from internal cylindrical surfaces.

### BACKGROUND

In typical highway tractor and trailer suspensions the axles are attached to beams which move up and down relative to the frame. The beam typically includes rubber bushings which are pressed into beam tubes defined by the beam, and oriented substantially perpendicular to the length of the beam. The axle thus is held in proper lateral relation to the frame, and may move up and down with respect to the frame against the force of a spring, airbag, or the like.

The rubber bushing flexes to allow some lateral movement during turns. When the bushing becomes worn, however, excessive lateral movement occurs, and the bushing must be replaced. Conventional tools are available to press the worn bushing out of the beam tube and press the new bushing in. Considerable effort is, however, required to clean the interior surface of the beam tube prior to installation of the new bushing. As the bushing flexes during use, dirt and the like enters between the outer rubber surface of the bushing and the interior wall of the beam tube. Further flexing forces this material onto the interior surface, forming deposits that are very difficult to remove by conventional methods. Presently it typically takes three or more hours of heating, chipping, scraping and grinding to clean a beam tube sufficiently to install a new bushing. Present methods can also damage the internal surface, removing steel as well as deposits. It is desired to remove deposits only, leaving the internal surface as original.

### SUMMARY OF THE INVENTION

It is the object of the present invention to provide an apparatus for removing deposits from the internal surface of a cylindrical tube, such as the beam tube on a highway trailer suspension, that accomplishes the task more quickly, and with less labour, than presently available tools and methods.

It is a further object of the invention to provide such an apparatus which does not damage the internal surface of the tube by providing a plurality of cutters mounted on a shaft and biased against the internal tube surface so as to be able to follow irregularities in the tube without binding or gouging.

It is a further object of the invention to provide such an apparatus that includes an air blast to blow debris and removed deposits out of the tube.

The invention provides, in one aspect, an apparatus for removing deposits from the internal surface of a substantially cylindrical tube having a tube axis, the apparatus comprising: a cap adapted for attachment to a first end of the tube, the cap defining a hole; a shaft slidably and rotatably mounted in the hole and having a shaft axis; a plurality of sockets at an inside end of the shaft, spaced about an exterior of the shaft, each socket extending outward from the shaft axis; a cutter base slidably mounted in each socket, each cutter base movable from a retracted position wherein a minimum length of cutter base extends from the socket, to an extended position; a conduit through the shaft adapted at an outside end thereof for attachment to a pressurized fluid source, an inside end thereof operatively connected to a lower portion of each socket such that the cutter base moves to the extended position in response to a force exerted by a supplied pressurized fluid; a cutter attached to an outer end of each cutter base; and a drive operative to rotate the shaft as the shaft slides along the hole.

The invention provides, in a second aspect, an apparatus for removing deposits from the internal surface of a substantially cylindrical tube having a tube axis, the apparatus comprising: a cap adapted for attachment to a first end of the tube, the cap defining a hole; a shaft slidably and rotatably mounted in the hole and having a shaft axis; a plurality of cutters extending outward from an inside end of the shaft, spaced about the exterior of the shaft, each cutter movable from a retracted position outward from the shaft to an extended position; means to connect a pressurized fluid source to provide a bias force acting on each cutter toward the extended position; and a drive operative to rotate the shaft as the shaft slides along the hole.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of the invention;

FIG. 2 is a perspective view of a beam tube that is suitable for cleaning with the embodiment of FIG. 1;

FIG. 3 is a cut-away side view of the embodiment of FIG. 1 in operation on the beam tube of FIG. 2;

FIG. 4 is a schematic end view of the embodiment of FIG. 1 in operation on the beam tube of FIG. 2;

FIG. 5 is a side view showing the retracted position of a cutter;

FIG. 5A is a side view showing the extended position of a cutter;

FIG. 6 is a schematic cross-sectional side view of the shaft and drive of the embodiment of FIG. 1;

FIG. 7 is a side view of a circular blade cutter and cutter base;

FIG. 8 is a front view of a notched circular blade cutter and cutter base;

FIG. 9 is a front view of a circular blade cutter and cutter base.

### DETAILED DESCRIPTION OF THE ILLUSTRATED EMBODIMENTS

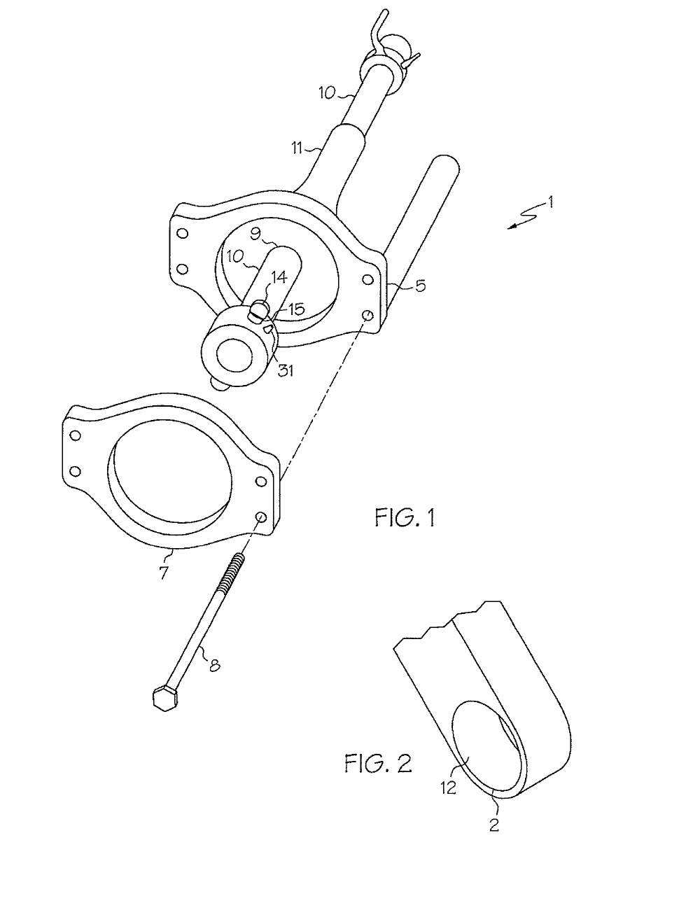

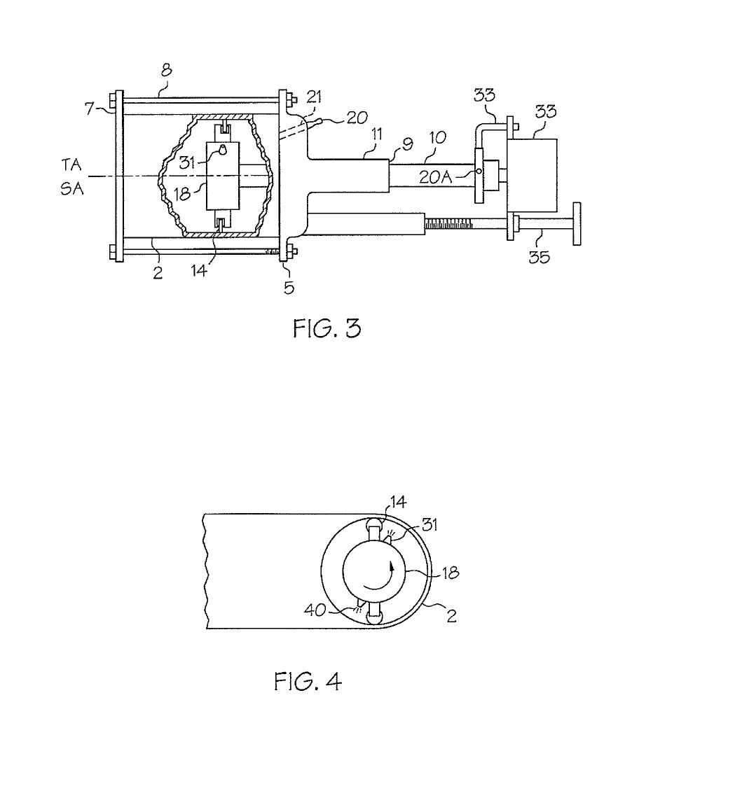

FIG. 1 illustrates an apparatus 1 of the invention for removing deposits from the internal surface 3 of a cylindrical tube 2 having a tube axis TA. FIG. 2 illustrates a tube 2 suitable for use with the apparatus 1, being a beam tube such as found on highway vehicle suspensions.

The apparatus 1 comprises a cap 5 adapted for attachment to a first end of the tube 2 using a clamp 7 and bolts 8. The opposite second end of the tube 2 is open.

The cap 2 defines a hole 9 and a shaft 10 is slidably and rotatably mounted in the hole 9 and has a shaft axis SA. When the apparatus 1 is mounted on the tube 2, the shaft axis SA is substantially coincidental with the tube axis TA. The hole 9 is extended by hole extension 11 so that the shaft 10 is maintained substantially in the desired alignment.

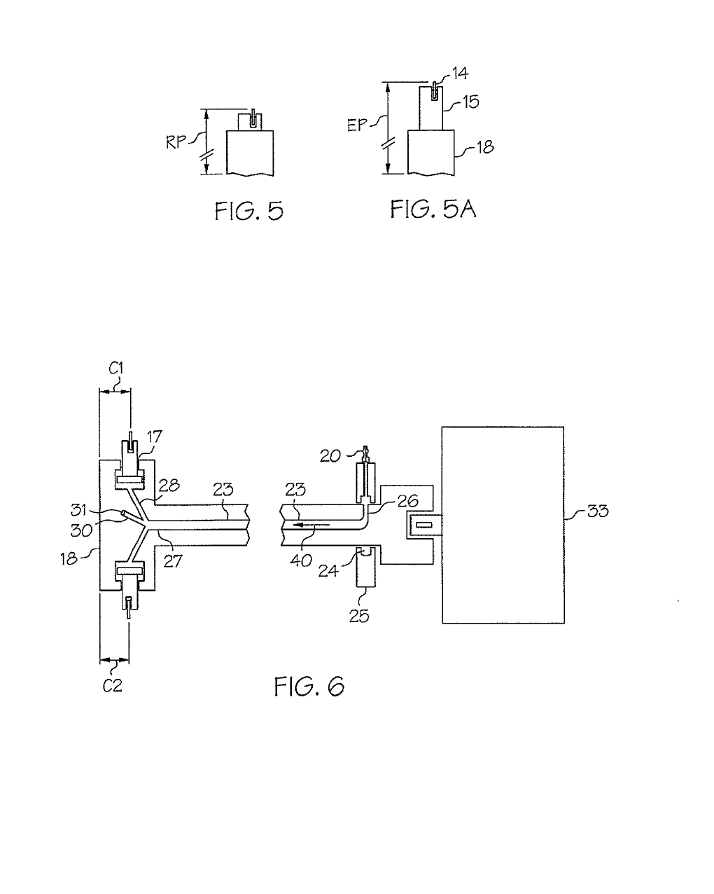

A plurality of cutters 14 extend outward from the inside end of the shaft 10, and toward the internal surface 12 of the tube 2. The cutters 14 are mounted on a cutter base 15 and are spaced about the exterior of the shaft 10. The cutter bases 15 are slidably mounted in a corresponding plurality of sockets 17 defined in a cutter mounting member 18 mounted on the inside end of the shaft 10. Each socket 17 extends outward from the shaft axis SA. As best seen in FIGS. 5, 5A each cutter 14 is movable from a retracted position RP outward from the cutter mounting member 18 and the shaft 10 to an extended position EP. Alternately the sockets 17 could be defined in the shaft 10 itself, however a larger diameter shaft 10 would be required, increasing the weight and making the apparatus 1 more cumbersome.

A bias force is provided by a pressurized fluid, most commonly compressed air although other gases or liquids could be used if conditions, such as availability, warranted. The bias force acts on each cutter 14 toward the extended position EP. With no pressurized fluid source attached, the cutters 14 can be moved to the retracted position RP and thus easily inserted into the tube 2 and the cap 5 can be clamped in place.

As best seen in FIG. 6, a conduit 23 in the shaft 10 is adapted at the outside end 26 thereof for attachment to a pressurized fluid source by attachment to a quick coupler 20. In order to allow rotation of the shaft 10 without rotating the quick coupler 20, the outside end 26 of the conduit 23 coincides with an annular channel 24 in supply ring 25 which rotates freely on the shaft 10. The annular channel 24 communicates with the quick coupler 20 screwed into the supply ring 25, thus providing a passage for pressurized fluid 40 to enter the conduit 23.

The inside end 27 of the conduit 23 is operatively connected to a lower portion of each socket 17 by ports 28 such that the cutter bases 15 move to the extended position EP in response to the force exerted by the pressurized fluid 40 when it is supplied.

As the cutters 14 rotate, deposits on the internal surface 12 of the tube 2 are removed. A channel is provided through the cap 5 so that a pressurized fluid source, such as compressed air or the like, can be can be attached to the quick coupler 20 and pressurized fluid 40 can be introduced through aperture 21 into the tube 2 to blow this debris out the open end of the tube 2 opposite the cap 5. The illustrated cap 5 covers the first end of the tube 2 so that debris is blown out the opposite open end of the tube 2 rather than back at the operator.

Alternately, the channel is provided by the conduit 23 and by an orifice 30 connecting the conduit 23 to the exterior of an inner portion of the shaft 10. As illustrated, an orifice 30 is located adjacent to each cutter 14 and terminates in a nozzle 31. The nozzle 31 directs pressurized fluid 40 outward from the shaft 10 and toward the internal surface 12 of the tube 2 adjacent to the cutter 14, thus providing a direct blast of pressurized fluid 40 to help remove loosened deposits.

A motor 33 is coupled to the shaft 10 and rotates it as the shaft 10 slides along the tube 2. The motor 33 engages a bracket 34 attached to the supply ring 25, and a feed drive screw 35 advances the motor 33 along the tube 2.

As illustrated in FIG. 6, the cutters 14 are offset along the shaft axis SA. The distance C1 is greater than the distance C2. The cutters 14 thus work on adjacent paths, rather than following each other. In the illustrated embodiments, there are two cutters 14 equally spaced about the shaft 10. Three or more cutters 14 could be used. Unequal spacing of the cutters 14 about the shaft 10 would be acceptable as the shaft 10 is maintained in position by the hole extension 11, however equal spacing results in substantially the same force being exerted on the shaft 10 from all sides.

The illustrated cutters 14 comprise a circular member 29 rotatably mounted about a cutter axis CA generally parallel to the shaft axis SA. In some conditions it may be desirable to run the circular members 29 at a small angle to the shaft axis SA to improve the cutting action.

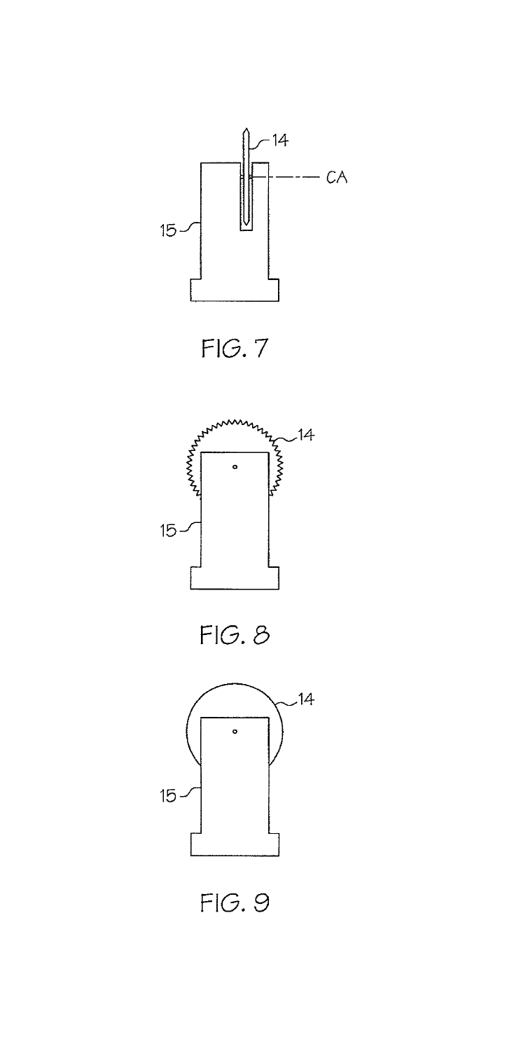

In FIGS. 7 and 9, the circular member 28 is a circular blade 28A having a sharpened periphery. The circular member 28B in FIG. 8 has a notched outer periphery, and may be sharpened as well. It is contemplated that different cutters will be developed for different purposes, some of which may be fixed to the cutter base 15, and all such variations are contemplated to fall within the scope of the present invention.

In operation, the inside end of the shaft 10, with the cutters 14 in the retracted position RP, is inserted into the tube 2 and the cover 5 is clamped in position. A pressurized fluid source is attached to quick-coupler 20A. The pressurized fluid 40 passes through the conduit 23 to the sockets 17, causing the cutters 14 to be forced towards the extended position and come to bear against the internal surface 12 of the tube 2. The motor 33 is started and the shaft 10 and cutters 14 begin to rotate. The cutters 14 and shaft 10 are advanced through the tube 2 by turning the feed drive screw 35. As the cutters 14 rotate, pressurized fluid 40 is also supplied to nozzles 31 adjacent the cutters 14 which direct a blast of pressurized fluid 40 towards the internal wall 12 and blow away loosened deposits and debris. As the first end of the tube 2 is covered by the cap 5, the pressurized fluid 40 exits the opposite second end of the tube 2 and carries the debris out with it. If necessary, the cutters 14 may be drawn repeatedly through the tube 2.

The bias force supplied by the pressurized fluid 40 keeps the cutters 14 bearing against the internal surface 12 of the tube 2, and yet the cutters may move in and out to follow irregularities in the surface 12. Damage to the surface 12 and binding of the apparatus 1 is thereby avoided.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. An apparatus for removing deposits from the internal surface of a substantially cylindrical tube having a tube axis, the apparatus comprising:
a cap adapted for attachment to a first end of the tube, the cap defining a hole;
a shaft slidably and rotatably mounted in the hole and having a shaft axis;
a plurality of sockets at an inside end of the shaft, spaced about an exterior of the shaft, each socket extending outward from the shaft axis;
a cutter base slidably mounted in each socket, each cutter base movable from a retracted position wherein a minimum length of cutter base extends from the socket, to an extended position;
a conduit through the shaft adapted at an outside end thereof for attachment to a pressurized fluid source, an inside end thereof operatively connected to a lower portion of each socket such that the cutter base moves to the extended position in response to a force exerted by a supplied pressurized fluid;
a cutter attached to an outer end of each cutter base; and
a drive operative to rotate the shaft as the shaft slides along the hole.

2. The apparatus of claim 1 further comprising a channel defined by the apparatus adapted at an outside end of the channel for attachment to a pressurized fluid source, an inside end thereof supplying pressurized fluid to an interior of a tube.

3. The apparatus of claim 2 wherein the cap is adapted to substantially cover the first end of the tube such that the pressurized fluid exits the tube through an opposite second end of the tube.

4. The apparatus of claim 3 wherein the channel is defined by the cap.

5. The apparatus of claim 2 wherein the channel is provided by the conduit and by an orifice connecting the conduit to an exterior of an inner portion of the shaft.

6. The apparatus of claim 5 further comprising a plurality of orifices, each orifice located adjacent to a cutter and adapted to direct pressurized fluid outward from the shaft.

7. The apparatus of claim 1 further comprising a cutter mounting member mounted on the inside end of the shaft, the cutter mounting member defining the sockets and a connection from the lower portion of each socket to the conduit.

8. The apparatus of claims 5 further comprising a cutter mounting member mounted on the inside end of the shaft, the cutter mounting member defining the sockets, a connection from the lower portion of each socket to the conduit, and the orifice.

9. The apparatus of claim 1 wherein the cutters are offset along the axis of the shaft.

10. The apparatus of claim 1 wherein at least one cutter comprises a circular member rotatably mounted about a cutter axis generally parallel to the shaft axis.

11. The apparatus of claim 10 wherein the circular member is a circular blade having a sharpened periphery.

12. The apparatus of claims 10 wherein the circular member has a notched outer periphery.

13. The apparatus of claim 1 wherein the cutters are equally spaced about the exterior of the shaft.

14. The apparatus of claim 1 further comprising a feed drive for advancing the cutters through the tube.

15. The apparatus of claim 1 wherein the cap is adapted for attachment to the first end of the tube using a clamp.

16. An apparatus for removing deposits from the internal surface of a substantially cylindrical tube having a tube axis, the apparatus comprising:
a cap adapted for attachment to a first end of the tube, the cap defining a hole;
a shaft slidably and rotatably mounted in the hole and having a shaft axis;
a plurality of cutters extending outward from an inside end of the shaft, spaced about the exterior of the shaft, each cutter movable, outward from the shaft, from a retracted position to an extended position;
means to connect a pressurized fluid source to provide a bias force acting on each cutter toward the extended position; and
a drive operative to rotate the shaft as the shaft slides along the hole.

17. The apparatus of claim 16 further comprising a channel defined by the apparatus adapted at an outside end of the channel for attachment to a pressurized fluid source, an inside end thereof supplying pressurized fluid to an interior of a tube.

18. The apparatus of claim 17 wherein the cap is adapted to substantially cover the first end of the tube such that the pressurized fluid exits the tube through an opposite second end of the tube.

19. The apparatus of claim 16 wherein the cutters are mounted on cutter bases slidingly received in sockets spaced about an exterior of the shaft, and wherein the bias force is exerted against a bottom of the cutter bases.

20. The apparatus of claim 16 wherein the means to provide a pressurized fluid source comprises a conduit extending through the shaft from an inside end connected to a bottom portion of each socket, to an outside end adapted for connection to the pressurized fluid source.

21. The apparatus of claim 17 wherein the means to provide a pressurized fluid source comprises a conduit extending through the shaft from an inside end connected to a bottom portion of each socket, to an outside end adapted for connection to the channel such that the channel and conduit receive pressurized fluid from the same pressurized fluid source.

22. The apparatus of claim 16 wherein the cutters are offset along the axis of the shaft.

23. The apparatus of claim 16 wherein at least one cutter comprises a circular member rotatably mounted about a cutter axis generally parallel to the shaft axis.

24. The apparatus of claim 23 wherein the circular member is a circular blade having a sharpened periphery.

25. The apparatus of claim 23 wherein the circular member has a notched outer circumference.

26. The apparatus of claim 16 wherein the cutters are equally spaced about the exterior of the shaft.
